(19) United States
(12) Patent Application Publication
(10) Pub. No.: US 2026/0027864 A1
(43) Pub. Date: Jan. 29, 2026

(54) THERMAL MANAGEMENT SYSTEM FOR VEHICLE AND METHOD OF CONTROLLING THE SAME

(71) Applicants: Hyundai Motor Company, Seoul (KR); Kia Corporation, Seoul (KR)

(72) Inventors: Ki Hoon KIM, Hwaseong-si (KR); Jae Kwon Lee, Hwaseong-si (KR); Se Kyu Oh, Hwaseong-si (KR); Jae Woong Kim, Hwaseong-si (KR); Dae Ki Hong, Hwaseong-si (KR)

(73) Assignees: Hyundai Motor Company, Seoul (KR); Kia Corporation, Seoul (KR)

(21) Appl. No.: 19/194,826

(22) Filed: Apr. 30, 2025

(30) Foreign Application Priority Data
Jul. 23, 2024 (KR) 10-2024-0097396

(51) Int. Cl. B60H 1/00

(52) U.S. Cl. CPC B60H 1/00392

(57) ABSTRACT

In a thermal management system for a vehicle and a method for controlling the same, the thermal management system includes a fluid transfer device configured to execute thermal management of at least one object, to be thermally managed, through introduced ambient air, and a controller configured to determine a target air flow rate required for thermal management of the at least one object to be thermally managed, and to control the fluid transfer device based on an optimal control value determined using a control model for a predictive state value according to a current state value and the target air flow rate.

### CROSS-REFERENCE TO RELATED APPLICATION

The present application claims priority to Korean Patent Application No. 10-2024-0097396 filed on Jul. 23, 2024, the entire contents of which is incorporated herein for all purposes by this reference.

### BACKGROUND OF THE PRESENT DISCLOSURE

### Field of the Present Disclosure

The present disclosure relates to a thermal management system for a vehicle, which is configured to perform thermal management of the vehicle based on optimal control through a predictive model.

### Description of Related Art

In pace with recently increased interest in the environment, use of eco-friendly vehicles provided with an electric motor as a driving source is increasing. Such an eco-friendly vehicle is also referred to as an “electrified vehicle”. As an example of such an electrified vehicle, there is a hybrid electric vehicle (HEV) or an electric vehicle (EV). Such an electrified vehicle not only consumes electrical energy for driving thereof, but also consumes electrical energy for internal air conditioning. For the present reason, efficiency of internal air conditioning greatly influences fuel economy of the vehicle and the overall energy efficiency including the internal air conditioning efficiency.

Among electrified vehicles, an electric vehicle, which is driven only through driving force of a motor without inclusion of an engine, requires greater energy efficiency because it is impossible to collect waste heat of an engine and then, to use such waste heat for internal air conditioning.

Furthermore, such an electrified vehicle includes parts such as a high-voltage battery, a motor, etc. for driving of the vehicle. Since operation performance of such parts is influenced by temperature, requirements associated with the parts have been further taken into consideration in terms of thermal management, in addition to internal air conditioning.

Accordingly, for an enhancement in energy efficiency of the entirety of the vehicle through optimal execution of thermal management of a vehicle, it is necessary to thoroughly take into consideration constraints for respective vehicle parts, a target for internal air conditioning, etc.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a thermal management system for a vehicle and a method for controlling the same, which are configured for executing integrated thermal management of the entirety of the vehicle, integrally taking into consideration thermal management requirements of various objects to be thermally managed, through a predictive model.

Objects of the present disclosure are not limited to the above-described object, and other objects of the present disclosure not yet described will be more clearly understood by those skilled in the art from the following detailed description.

In accordance with an aspect of the present disclosure, the above and other objects may be accomplished by the provision of a thermal management system for a vehicle including a fluid transfer device including an inlet configured to introduce ambient air around the vehicle therein, an opening/closing device configured to adjust an opening amount of the inlet, and a blowing device configured to adjust a flow rate of the ambient air introduced into the inlet, the fluid transfer device being configured to execute thermal management of at least one object, to be thermally managed, through the introduced ambient air, and a controller configured to determine a target air flow rate required for thermal management of the at least one object to be thermally managed, and to control the fluid transfer device based on an optimal control value determined using a control model for a predictive state value according to a current state value and the target air flow rate, wherein the optimal control value is a control value enabling the fluid transfer device to execute the thermal management of the at least one object, to be thermally managed, through minimum consumption of electric power while satisfying constraints for the target air flow rate.

In accordance with another aspect of the present disclosure, there is provided a method for controlling a thermal management system for a vehicle including a fluid transfer device including an inlet configured to introduce ambient air around the vehicle therein, an opening/closing device configured to adjust an opening amount of the inlet, and a blowing device configured to adjust a flow rate of the ambient air introduced into the inlet, the fluid transfer device being configured to execute thermal management of at least one object, to be thermally managed, through the introduced ambient air, the method including determining a target air flow rate required for thermal management of the at least one object to be thermally managed, and controlling the fluid transfer device based on an optimal control value determined using a control model for a predictive state value according to a current state value and the target air flow rate, wherein the optimal control value is a control value enabling the fluid transfer device to execute the thermal management of the at least one object, to be thermally managed, through minimum consumption of electric power while satisfying constraints for the target air flow rate.

In accordance with various embodiments of the present disclosure as described above, it may be possible to easily, conveniently, and accurately determine optimal operation points of a plurality of objects to be controlled, which operate for thermal management of a plurality of objects to be thermally managed, in various vehicle driving scenarios. Accordingly, it may be possible to enhance performance and efficiency of thermal management of the entirety of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram showing an example of a configuration of a fluid transfer device applicable to various exemplary embodiments of the present disclosure;

FIG. 2 is a diagram showing a configuration of a vehicle thermal management system according to an exemplary embodiment of the present disclosure;

FIG. 3 is a diagram explaining an optimal control procedure of a controller according to an exemplary embodiment of the present disclosure;

FIG. 4 is a diagram explaining a configuration of a controller and operation thereof according to an exemplary embodiment of the present disclosure; and

FIG. 5 is a flowchart explaining a thermal management execution procedure for a vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

For embodiments of the present disclosure included herein, specific structural or functional descriptions are exemplary to merely describe the exemplary embodiments of the present disclosure, and the exemplary embodiments of the present disclosure may be implemented in various forms and should not be interpreted as being limited to the exemplary embodiments described in the present specification.

As various modifications may be made and diverse embodiments are applicable to the exemplary embodiments according to the concept of the present disclosure, specific embodiments will be illustrated with reference to the accompanying drawings and described in detail herein. However, these specific embodiments should not be construed as limiting the exemplary embodiments according to the concept of the present disclosure, but should be construed as extending to all modifications, equivalents, and substitutes included in the concept and technological scope of the present disclosure.

Unless defined otherwise, terms used herein including technological or scientific terms have the same meaning as generally understood by those of ordinary skill in the art to which the present disclosure pertains. The terms used herein shall be interpreted not only based on the definition of any dictionary but also the meaning which is used in the field to which the present disclosure pertains. Furthermore, unless clearly defined, the terms used herein shall not be interpreted too ideally or formally.

Hereinafter, various exemplary embodiments of the present disclosure will be described in detail with reference to the accompanying drawings, and the same or similar elements are designated by the same reference numerals regardless of the numerals in the drawings and redundant description thereof will be omitted.

In the following description of embodiments, the term “predetermined” means that, when a parameter is used in a process or an algorithm, the numerical value of the parameter has been previously determined. The numerical value of the parameter may be set when the process or the algorithm is begun or during a period in which the process or algorithm is executed in accordance with an exemplary embodiment of the present disclosure.

The suffixes “module” and “unit” of elements herein are used for convenience of description and thus may be used interchangeably and do not have any distinguishable meanings or functions.

In the following description of the exemplary embodiments of the present disclosure, a detailed description of known technologies incorporated herein will be omitted when it may obscure the subject matter of the exemplary embodiments of the present disclosure. Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions include a plural meaning.

In the present specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

A controller or a control unit may include a communication device configured to communicate with another controller or a sensor, for control of a function to be performed thereby, a memory configured to store an operating system, logic commands, input/output information, etc., and at least one processor configured to execute discrimination, calculation, determination, etc. required for control of the function to be performed.

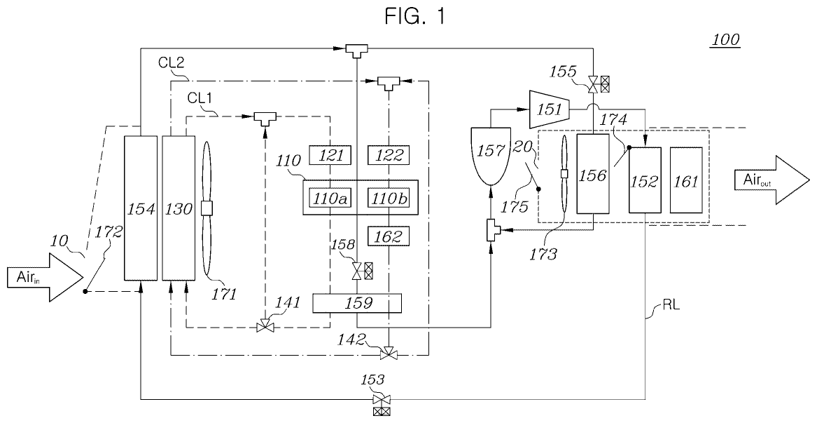

Hereinafter, an example of a fluid transfer device applicable to various exemplary embodiments of the present disclosure will be first described with reference to FIG. 1.

FIG. 1 is a diagram showing an example of a configuration of a fluid transfer device applicable to various exemplary embodiments of the present disclosure.

Referring to FIG. 1, a fluid transfer device 100, which is applicable to various exemplary embodiments of the present disclosure, may perform vehicle thermal management such as cooling or heating of at least one vehicle part 110, air conditioning of a vehicle interior (a cabin), etc.

For the present function, the fluid transfer device 100 may not only include coolant lines CL1 and CL2 configured to exchange heat with the vehicle part 100, but also may include a refrigerant line RL configured to exchange heat with coolant and ambient air.

In more detail, a plurality of coolant lines CL1 and CL2 may be provided at the fluid transfer device 100, and the coolant lines CL1 and CL2 may individually exchange heat with different vehicle parts 110, respectively, for heat management of the vehicle parts 110.

Here, the vehicle parts 110 may include a driving system 110a such as a motor, an inverter, etc., and a battery 110b. Of course, in embodiments of the present disclosure, the vehicle parts 110 are not limited to the above-described conditions, and may include various parts requiring dissipation of heat generated therefrom. For example, the vehicle parts 110 may include various types of controllers such as an autonomous-driving controller, a motor controller, a vehicle controller, a controller associated with execution of integrated thermal management according to an exemplary embodiment of the present disclosure, etc.

Although the coolant line CL1 for thermal management of the driving system 110a and the coolant line CL2 for thermal management of the battery 110b are shown in FIG. 1, the coolant lines CL1 and CL2 as described above may be substituted by coolant lines for thermal management of other vehicle parts 110 such as a controller, etc. or may coexist with the coolant lines for thermal management of the other vehicle parts 110. Furthermore, in an illustrative implementation of the fluid transfer device 100, various cases including the case in which only a single coolant line for thermal management of only one vehicle part 110 is provided, the case in which a plurality of vehicle parts 110 is connected in series to one coolant line, etc. may be included.

Pumps 121 and 122 may be provided at respective coolant lines CL1 and CL2, for circulation of coolant. The pumps 121 and 122 may feed the coolant to the side of the vehicle part 110, through consumption of electric power. For example, each of the pumps 121 and 122 as described above may be implemented by an electric water pump (EWP) configured to circulate coolant by driving a motor through electrical energy.

The coolant introduced to the side of the vehicle part 110 through the pumps 121 and 122 may absorb heat generated from the vehicle part 110 through heat-exchange with the vehicle part 110 while passing through the vehicle part 110. Accordingly, cooling of the vehicle part 110 may be achieved.

The coolant emerging from the vehicle part 110 may flow to the side of a radiator 130. The coolant may dissipate heat absorbed from the vehicle part 110 through heat-exchange with the radiator 130 while passing through the radiator 130, and may again be introduced to the side of the vehicle part 110.

In the instant case, the radiator 130 may be provided at each of the coolant lines CL1 and CL2 in an individual manner. In the instant case, radiators 130 respectively corresponding to the coolant lines CL1 and CL2 may be classified into, for example, a high-temperature radiator and a low-temperature radiator, respectively.

A compressor 151, a plurality of condensers 152 and 154, a plurality of expanders 153, 155, and 158, an evaporator 156, an accumulator 157, and a heat absorber 159 may be provided at the refrigerant line RL.

In the instant case, the compressor 151 may discharge refrigerant in a high-temperature and high-pressure state through consumption of electric power, for implementation of the heat pump function through circulation of the refrigerant. The refrigerant emerging from the compressor 151 repeat heat dissipation and heat absorption while passing through an indoor condenser, that is, the condenser 152, the expander 153, an outdoor condenser, that is, the condenser 154, the expander 155, the evaporator 156, and the accumulator 157.

The refrigerant line RL may pass through portions of the coolant lines CL1 and CL2 to collect waste heat of the vehicle part 110 from the coolant lines CL1 and CL2. In the instant case, the refrigerant line RL may exchange heat with the coolant lines CL1 and CL2 through the heat absorber 159 connected to the coolant lines CL1 and CL2. Meanwhile, the fluid transfer device 100 may include a plurality of heat absorbers 159, differently from the case shown in FIG. 1, and the plurality of heat absorbers 159 may be connected to different ones of the coolant lines CL1 and CL2, respectively.

Meanwhile, for execution of vehicle thermal management for different purposes, the fluid transfer device 100 may form various heat transfer paths through the coolant lines CL1 and CL2.

For example, the coolant line CL1 for thermal management of the driving system 110a may form a heat transfer path configured to outwardly dissipate heat absorbed from the driving system 110a through the radiator 130, and a heat transfer path configured to transfer the heat absorbed from the driving system 110a to the refrigerant line RL through the heat absorber 159. The coolant line CL1 may simultaneously form the above-described heat transfer paths.

The above-described heat transfer paths may be varied in accordance with a flow direction of the coolant, and the flow direction of the coolant may be adjusted by a valve 141 or the like provided at the coolant line CL1. Furthermore, circulation of the coolant may be suppressed through stop of operation of the pump 121 to prevent heat generated from the driving system 110a from being dissipated through the radiator 130 or the heat absorber 159.

In another example, the coolant line CL2 for thermal management of the battery 110b may form a heat transfer path configured to outwardly dissipate heat absorbed from the battery 110b through the radiator 130, and a heat transfer path configured not to pass through the radiator 130. In the heat transfer path configured not to pass through the radiator 130, heat generated from the battery 110b may be transferred to the refrigerant line RL through the heat absorber 159 in accordance with circulation of the refrigerant in the refrigerant line RL, and, accordingly, the battery 110b may be cooled. Otherwise, in place of transfer of heat to the refrigerant line RL, heat of the coolant heated through a heater 162 configured to heat the coolant may be transferred to the battery 110b in the heat transfer path configured not to pass through the radiator 130, and, accordingly, the battery 110b may be heated. The above-described heat transfer paths may be varied in accordance with a flow direction of the coolant, and the flow direction of the coolant may be adjusted by a valve 142 or the like provided at the coolant line CL2.

The fluid transfer device 100 may collect heat generated from the vehicle part 110, that is, waste heat, through the heat transfer path configured to transfer heat absorbed from the vehicle part 110 to the refrigerant line RL through the heat absorber 159, among the above-described heat transfer paths, to re-use the collected heat for thermal management of a vehicle interior. Accordingly, energy efficiency of vehicle thermal management may be enhanced.

Meanwhile, the fluid transfer device 100 may perform thermal management of the vehicle through heat-exchange thereof with ambient air. During execution of thermal management as described above, the fluid transfer device 100 may adjust air flow from the external to the interior. For adjustment of air flow, the fluid transfer device 100 may include a blowing device, an opening/closing device, etc.

The blowing device may include, for example, a cooling fan 171 configured to adjust introduction of ambient air, and a blower 173 configured to adjust discharge of air into the vehicle interior. The opening/closing device may include, for example, an air flap 172 configured to adjust introduction of ambient air, a temperature door 174 configured to adjust a temperature of air discharged into the vehicle interior, and an ambient air door 175 mounted at an inlet 20 and configured to adjust introduction of ambient air into the vehicle interior. Electric power may be consumed for execution of operation of the blowing device and the opening/closing device.

Furthermore, the fluid transfer device 100 may include an electric heating device configured to increase a temperature of air or coolant. The electric heating device may include a heater 161 configured to heat air discharged into the vehicle interior. In the instant case, the heater 161 may be implemented by, for example, a positive temperature coefficient (PTC) heater. Furthermore, the electric heating device may include the heater 162 which is configured to heat coolant for an increase in temperature of the battery 110b, as described above.

In accordance with the above-described configuration of the fluid transfer device 100, thermal management of the vehicle may be conducted in various manners. The various thermal management scenarios may be devised in accordance with an internal state of the vehicle, an external state of the vehicle, states of the vehicle parts 110a and 110b, etc. For execution of optimized thermal management for various thermal management scenarios, it is necessary to determine a control value configured for comprehensively satisfying thermal management requirements of a plurality of objects to be thermally managed in each scenario.

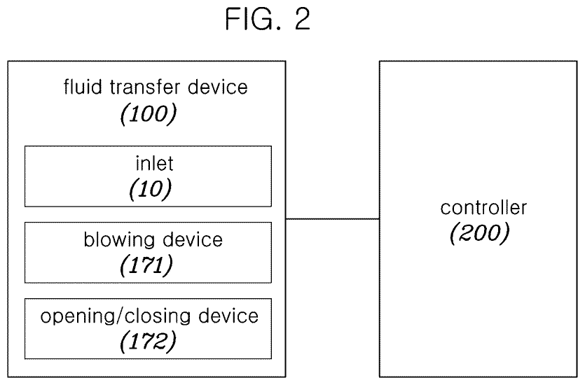

Accordingly, in an exemplary embodiment of the present disclosure, it is provided to execute integrated thermal management of the entirety of the vehicle, comprehensively taking into consideration thermal management requirements of various objects through a predictive model, in place of determination of a flow rate of air on a map basis. A vehicle thermal management system for execution of the integrated thermal management of the entirety of the vehicle will be described with reference to FIG. 2.

FIG. 2 is a diagram showing a configuration of the vehicle thermal management system according to an exemplary embodiment of the present disclosure.

Referring to FIG. 2, the vehicle thermal management system according to the exemplary embodiment of the present disclosure may include a fluid transfer device 100 and a controller 200.

First, the fluid transfer device 100 may include an inlet 10, a blowing device 171, and an opening/closing device 172. Of course, FIG. 2 mainly shows constituent elements associated with the description of an exemplary embodiment of the present disclosure, and the fluid transfer device 100 may be implemented through inclusion of a greater or smaller number of constituent elements than that of the shown constituent elements.

The inlet 10 is configured to introduce ambient air around the vehicle therein, and may be provided at one end side of the fluid transfer device 100. The blowing device 171 may adjust a flow rate of air introduced into the inlet 10, and the opening/closing device 172 may adjust an opening amount of the inlet 10. The blowing device 171 and the opening/closing device 172 as described above may be provided at a downstream end of the inlet 10 in an introduction direction of ambient air, as shown in FIG. 1.

In the instant case, for example, the inlet 10 may be provided at a front underhood of the vehicle, the blowing device 171 may be a fan configured to be driven through a motor, and the opening/closing device 172 may be a flap or a door configured to rotate about an axis. Meanwhile, in an exemplary embodiment of the present disclosure, the opening/closing device 172 may continuously adjust the opening amount of the inlet 10 between a fully-closed state and a fully-opened state. Of course, the opening/closing device 172 is not limited to the above-described condition, and may be implemented in a multi-stage control manner in which the opening amount is discontinuously adjusted.

The fluid transfer device 100 may perform thermal management of at least one of objects, to be thermally managed, included in the vehicle, using ambient air introduced through the inlet 10, the opening/closing device 171, and the blowing device 172 as described above. In the instant case, for example, the thermal management may be achieved through heat-exchange between at least one object to be thermally managed and introduced ambient air, and may include concepts such as cooling, heating, temperature increase, temperature decrease, etc. Furthermore, in the object to be thermally managed, objects configured to be varied in temperature and to satisfy a target temperature value thereof or a target temperature range thereof, such as a vehicle interior (cabin), a battery, a motor, an inverter, a controller, etc., may be included.

The controller 200 may be configured to determine a target air flow rate required for thermal management of at least one object to be thermally managed, and may be configured for controlling the fluid transfer device 100 based on an optimal control value and the determined target air flow rate.

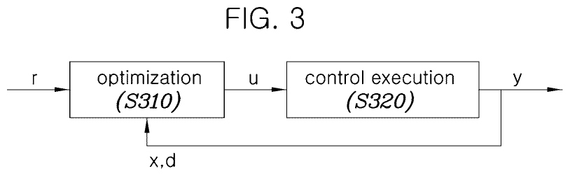

The optimal control value may be determined using a control model for a predictive state value according to a current state value. This will be descried with reference to FIG. 3.

Referring to FIG. 3, in accordance with an exemplary embodiment of the present disclosure, the controller 200 may perform vehicle thermal management through procedures of optimization S310 and control execution S320.

First, the optimization procedure S310 may be executed on a model basis. For example, proportional-integral-derivative (PID) control, linear-quadratic regulator (LQR) control, etc. may be used for optimization. In in accordance with an exemplary embodiment of the present disclosure, the optimization procedure S310 may be executed through model-based predictive control.

In more detail, the optimization procedure S310 through the model-based predictive control may be executed in a direction decreasing a future error in deriving an optimal control value u enabling an output value y to trace a target value r.

The optimal control value u may be determined using a control model for a predictive state value according to a current state value x. That is, the optimal control value u may be determined taking into consideration not only a current state, but also a predictive future state.

At least one of a current control value u or a disturbance d as well as the current state value x may be further reflected in the control model for the predictive state value. For example, this may be expressed by the following expression.

$${x}_{k + 1} = {A}_{k} {x}_{k} + {B}_{k} {u}_{k} + {B}_{w , k} {w}_{k} + {B}_{∅ , k}$$

In the present expression, x_{□} and xₖ₊₁ represent the current state value and the predictive state value, respectively, and w_{□} represents the disturbance. A_{□}, and B_{□}, and B_{w,k} represent influence of the current state, a control input, and the disturbance on the future state, respectively. B_{ø,k} is an item for reflecting uncertainty of prediction. It may be possible to reflect a predicted future state in derivation of an optimal control value by use of the control model for the predictive state value.

In an exemplary embodiment of the present disclosure, in the state value x, at least one of a flow rate of ambient air introduced through the inlet 10 or a coefficient of drag may be included. In the control value u, at least one of an opening amount of the inlet 10 or a required operation quantity of the blowing device 171 may be included. Furthermore, at least one of a vehicle speed or a temperature of ambient air may be included in the disturbance d.

In the instant case, the predictive state value for the flow rate of ambient air may be determined in accordance with the control value u such as an opening amount of the inlet 10 and a required operation quantity of the blowing device 171, and the disturbance d such as a vehicle speed and a temperature of ambient air. Furthermore, the coefficient of drag may be determined in accordance with an opening amount of the inlet 10.

Meanwhile, in the optimization procedure S310, optimization of the target value r may also be executed before derivation of the optimal control value u. In the instant case, optimization of the target value r may be executed in a normal state, and a control model for an output value may be used in optimization of the target value r. In the instant case, the control module for the output value represents the current state value and an output value according to the current control value. For example, the present control model may be expressed by the following expression.

$$[ \begin{matrix}{A}_{k} - I & {B}_{k} \\ {C}_{k} & O\end{matrix} ] [ \begin{matrix}{x}_{ss} \\ {u}_{ss}\end{matrix} ] = [ \begin{matrix}- ( {B}_{w , k} {w}_{k} + {B}_{∅ , k} \\ r\end{matrix} ]$$

In the present expression, x_{□□} and u_{□□} represent a state value and a control value in a normal state, respectively, and w_{□} represents a disturbance. A_{□}, B_{□}, and B_{w,k} represent influence of a current state, a control input, and the disturbance on a future state, respectively, and C_{□} represents influence of a state value on an output value. r may represent a target value, that is, an output value as a target of control. B_{ø,k} is an item for reflecting uncertainty of prediction.

Differently from the above-described case, the optimization procedure for the target value r in the normal state may be omitted in an exemplary embodiment of the present disclosure. In the instant case, optimization may be executed in a dynamic state in which there is a variation in state value so that an output value traces a target value.

Meanwhile, in the optimization procedure S310 through the model-based predictive control, the optimal control value u may be determined through a cost function for a predetermined predictive range.

Here, the predetermined predictive range represents how far ahead the future is predicted, and may be expressed by a prediction horizon. When the predictive range increases, performance of optimization may be enhanced. Of course, computational load of the controller 200 for prediction may be increased, corresponding to the increased prediction range.

In an exemplary embodiment of the present disclosure, the cost function may reflect, therein, consumed electric power of the blowing device 171 and an air resistance load for a predetermined predictive range. For example, the cost function may be expressed by the following expression.

$$J = {\sum }_{k = 0}^{N - 1} ( {P}_{fan , k} + {P}_{aerores , k} )$$

In the present expression, J represents the cost function, P_{fan,k} represents the consumed electric power of the blowing device 171, and P_{aerores,k} represents the air resistance load. The consumed electric power of the blowing device 171 may be determined based on a vehicle speed and a required operation quantity of the blowing device 171, and the air resistance load may be determined based on the opening amount of the inlet 10 and the vehicle speed.

Meanwhile, for determination of the cost function as described above, the controller 200 may take constraints into consideration. In an exemplary embodiment of the present disclosure, the constraints may be associated with a target air flow rate. In more detail, the constraints may be satisfied when a flow rate of ambient air introduced into the inlet 10 is not less than a target air flow rate. Accordingly, the controller 200 may determine, as an optimal control value u, an opening amount of the inlet 10 and a required operation quantity of the blowing device 171 at which the flow rate of ambient air introduced into the inlet 10 is not less than the target air flow rate, and the cost function is minimized.

After execution of the optimization procedure S310 as described above, substantial control for constituent elements of the fluid transfer device 100 is executed in accordance with the optimal control value u (S320), and results of execution of the control may be represented in a form of an output value y. In the instant case, the output value y may be collected through various sensors provided in the vehicle, and may be again transmitted to the controller 200, if necessary. In the instant case, the controller 200 may be configured to determine a current state x and a disturbance d in accordance with the output value y, and may be again reflected in the optimization procedure S310.

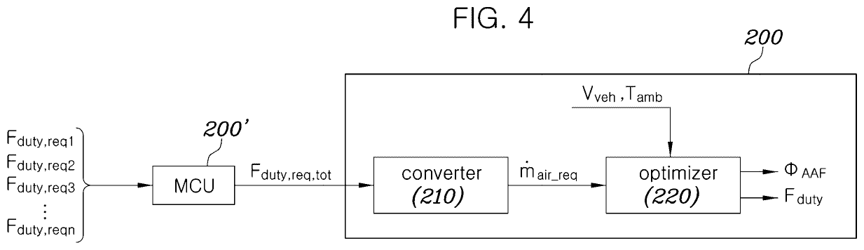

Hereinafter, a detailed configuration of the controller 200 and operation thereof will be described with reference to FIG. 4.

FIG. 4 is a diagram explaining a configuration of the controller and operation thereof according to an exemplary embodiment of the present disclosure.

Referring to FIG. 4, the controller 200 may include a converter 210 and an optimizer 220. The controller 200 may perform control for thermal management in cooperation with a separate controller such as a motor control unit (MCU) 200′. Of course, FIG. 3 is only illustrative. In another illustrative implementation, operation executed by the motor control unit 200′ may be executed by the controller 200. Hereinafter, control operations executed by respective constituent elements will be described.

First, the motor control unit 200′ may obtain required operation quantities F_{duty, req1}, F_{duty, req2}, F_{duty, req3}, . . . , and F_{duty, reqn}, for thermal management of a plurality of objects to be thermally managed, may be configured to generate a total required operation quantity F_{duty,req.tot}, through synthesis of the obtained required operation quantities, and may then transmit the total required operation quantity F_{duty,req.tot} to the controller 200.

In the instant case, total required operation quantity F_{duty,req.tot} corresponds to a driving duty of the blowing device 171, and, accordingly, the converter 210 may convert the total required operation quantity F_{duty,req.tot} into a target air flow rate \dot{m}_{air_req} which is a physical quantity.

The optimizer 220 may determine an optimal control value enabling the fluid transfer device 100 to execute thermal management of objects to be thermally managed through minimum consumption of electric power while satisfying constraints for the target air flow rate \dot{m}_{air_reg}, based on a vehicle speed Vᵥₑₕ and an ambient air temperature T_{amb} as well as the converted target air flow rate \dot{m}_{air_req}.

In the instant case, the optimizer 220 may determine the optimal control value using the control model for the predictive state value and the cost function reflecting, therein, consumed electric power of the blowing device 171 and an air resistance load throughout a predetermined predictive range. The optimal control value may be output in a form of an opening amount ϕ_{AAF} of the inlet 10 and an operation quantity F_{duty} of the blowing device 171.

The output optimal control value is transmitted to the blowing device 171 and the opening/closing device 172 which are objects to be controlled, and the blowing device 171 and the opening/closing device 172 adjust introduction of ambient air based on the optimal control value.

Hereinafter, the thermal management execution procedure described heretofore will be described with reference to a flowchart.

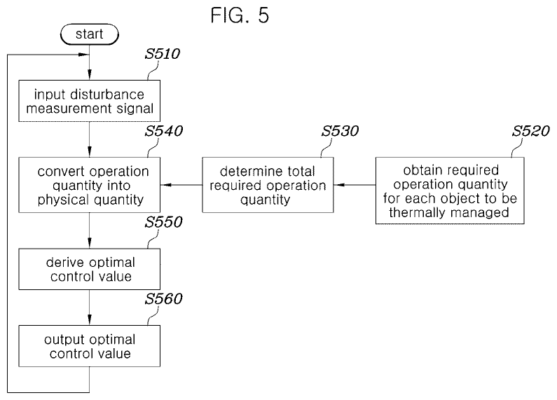

FIG. 5 is a flowchart explaining a thermal management execution procedure for the vehicle according to an exemplary embodiment of the present disclosure.

Referring to FIG. 5, the controller 200 may first receive a disturbance measurement signal such as vehicle speed and outside temperature (S510). In the instant case, a vehicle speed and an ambient air temperature may be included in a disturbance. Furthermore, the controller 200 may receive required operation quantities of the blowing device 171 for thermal management of respective objects to be thermally managed (S520), and may convert a total required operation quantity determined based on the required operation quantities (S530) into a physical quantity including the form of a target air flow rate (S540).

Thereafter, the controller 200 may determine an optimal control value based on the received disturbance and the converted target air flow rate (S550). In the instant case, for execution of the optimal control value, the controller 200 may use a cost function reflecting, therein, consumed electric power of the blowing device 171 and an air resistance load and a control model for a predictive state value.

The optimal control value determined as described above may be output in a form of an operation quantity of the blowing device 171 and an opening amount of the opening/closing device 172 (S560). In in accordance with the optimal control value, the blowing device 171 and the opening/closing device 172 operate.

As apparent from the above description, in accordance with various embodiments of the present disclosure as described above, it may be possible to easily, conveniently, and accurately determine optimal operation points of a plurality of objects to be controlled, which operate for thermal management of a plurality of objects to be thermally managed, in various vehicle driving scenarios, and accordingly, to enhance performance and efficiency of thermal management of the entirety of the vehicle.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the non-transitory computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A thermal management system for a vehicle, the system comprising:
a fluid transfer device including an inlet introducing ambient air around the vehicle therein, an opening/closing device adjusting an opening amount of the inlet, and a blowing device adjusting a flow rate of the ambient air introduced into the inlet, wherein the fluid transfer device executes thermal management of at least one object, to be thermally managed, through the introduced ambient air; and
a controller configured to determine a target air flow rate required for thermal management of the at least one object to be thermally managed, and to control the fluid transfer device based on an optimal control value determined using a control model for a predictive state value according to a current state value and the target air flow rate,
wherein the optimal control value is a control value enabling the fluid transfer device to execute the thermal management of the at least one object, to be thermally managed, through minimum consumption of electric power while satisfying constraints for the target air flow rate.

2. The thermal management system of claim 1, wherein the opening/closing device continuously adjusts the opening amount of the inlet between a fully-closed state and a fully-opened state.

3. The thermal management system of claim 1, wherein the controller is configured to determine the target air flow rate based on a total required operation quantity of the blowing device required for the thermal management of the at least one object to be thermally managed.

4. The thermal management system of claim 1, wherein the current state value and the predictive state value include at least one of a flow rate of the ambient air introduced into the inlet or a coefficient of drag according to the opening amount of the inlet.

5. The thermal management system of claim 4, wherein the control value includes at least one of the opening amount of the inlet or a required operation quantity of the blowing device.

6. The thermal management system of claim 5, wherein the control model for the predictive state value further reflects influence of the control value on a state value therein.

7. The thermal management system of claim 4, wherein the control model for the predictive state value further reflects influence of a disturbance on a state value including at least one of a vehicle speed and an ambient air temperature.

8. The thermal management system of claim 1, wherein the controller is configured to determine the optimal control value based on a cost function reflecting consumed electric power of the blowing device throughout a predetermined predictive range.

9. The thermal management system of claim 8, wherein the cost function further reflects the opening amount of the inlet and an air resistance load according to a vehicle speed.

10. The thermal management system of claim 1, wherein the constraints for the target air flow rate are satisfied in response that the flow rate of the ambient air is greater than or equal to the target air flow rate.

11. A method for controlling a thermal management system for a vehicle including a fluid transfer device including an inlet introducing ambient air around the vehicle therein, an opening/closing device adjusting an opening amount of the inlet, and a blowing device adjusting a flow rate of the ambient air introduced into the inlet, wherein the fluid transfer device executes thermal management of at least one object, to be thermally managed, through the introduced ambient air, the method comprising:
determining, by a processor, a target air flow rate required for thermal management of the at least one object to be thermally managed; and
controlling, by the processor, the fluid transfer device based on an optimal control value determined using a control model for a predictive state value according to a current state value and the target air flow rate,
wherein the optimal control value is a control value enabling the fluid transfer device to execute the thermal management of the at least one object, to be thermally managed, through minimum consumption of electric power while satisfying constraints for the target air flow rate.

12. The method of claim 11, wherein the opening/closing device continuously adjusts the opening amount of the inlet between a fully-closed state and a fully-opened state.

13. The method of claim 11, wherein the determining of the target air flow rate includes determining the target air flow rate based on a total required operation quantity of the blowing device required for the thermal management of the at least one object to be thermally managed.

14. The method of claim 11, wherein the current state value and the predictive state value include at least one of a flow rate of the ambient air introduced into the inlet or a coefficient of drag according to the opening amount of the inlet.

15. The method of claim 14, wherein the control value includes at least one of the opening amount of the inlet or a required operation quantity of the blowing device.

16. The method of claim 15, wherein the control model for the predictive state value further reflects influence of the control value on a state value therein.

17. The method of claim 14, wherein the control model for the predictive state value further reflects, therein, influence of a disturbance on a state value including at least one of a vehicle speed and an ambient air temperature.

18. The method of claim 11, wherein the optimal control value is determined based on a cost function reflecting, therein, consumed electric power of the blowing device throughout a predetermined predictive range.

19. The method of claim 18, wherein the cost function further reflects the opening amount of the inlet and an air resistance load according to a vehicle speed.

20. The method of claim 11, wherein the constraints for the target air flow rate are satisfied in response that the flow rate of the ambient air is greater than or equal to the target air flow rate.
